(19) United States
(12) Patent Application Publication
(10) Pub. No.: US 2010/0100360 A1
(43) Pub. Date: Apr. 22, 2010

(54) MODEL-BASED ROAD SURFACE CONDITION IDENTIFICATION

(75) Inventors: Weiwen Deng, Rochester Hills, MI (US); Haicen Zhang, Windsor (CA); Qingrong Zhao, Sterling Heights, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., Detroit, MI (US)

(21) Appl. No.: 12/252,592

(22) Filed: Oct. 16, 2008

(51) Int. Cl. G06F 17/10

(52) U.S. Cl. 703/2

(57) ABSTRACT

A method is provided for determining a state of a road condition using a linear model-based estimation technique. Two vehicle reference models are defined to represent vehicles operating under non-slippery and slippery road surfaces respectively. An index that reflects the vehicle understeer characteristics is also defined. Indices are determined from the reference models under the non-slippery road surface, the slippery road surface, and from vehicle sensor measurement, respectively. A first root mean square deviation is calculated between the index of reference model under non-slippery road surface and the index calculated based on sensor measurement. A second root mean square deviation is calculated between the index of reference model under slippery road surface and the index calculated based on sensor measurement. A probability analysis is applied as a function of probability density functions for identifying the condition of the road surface between a non-slippery road surface and a slippery road surface.

### BACKGROUND OF INVENTION

An embodiment relates generally to identifying whether a road surface is in non-slippery or slippery condition based on a normal driving maneuver.

Road surface condition estimation systems are typically based on a nonlinear tire model which uses predefined characteristics under varying road surfaces to differentiate the different road surfaces. Such an approach typically requires evasive driving maneuvers to generate large lateral excitation for the tire to operate in nonlinear or near-limit region, where significant differences can be detected. However, many active safety and driver-assist features mainly operate under normal driving maneuvers which keep the tire in the linear operating region and do not generate the needed large excitation. Moreover, such a tire model may not be accurate and consistent in determining tire characteristics while operating the vehicle under various road surfaces due to unknown factors such as tire wear and tire pressure. Tire models in general do not reflect the tire dynamic characteristics. Lastly, many road surface friction and condition estimation systems typically require additional sensors such as remote-sensing or corner force measurements which require additional cost for the added sensors.

### SUMMARY OF INVENTION

An advantage of an embodiment of the invention is the use of a linear model-based approach which, fully capturing the sensitiveness of vehicle understeer characteristics to road surface conditions, works well under normal driving maneuvers in comparison to methods mentioned above, and reduces additional hardware and the associated cost of the additional hardware as well in comparison to remote-sensing or many road friction estimation methods.

A method is provided for determining a state of a road condition using a linear model-based estimation technique. An index is determined which represents a vehicle understeer characteristic for a vehicle model based on a non-slippery road surface. An index is determined which represents a vehicle understeer characteristic for a vehicle model based on a slippery road surface. An index is determined based on measured vehicle operating characteristics that include a yaw rate sensor measurement. A first root mean squared deviation is calculated for an error between the index from the model based on the non-slippery road surface and the index calculated from sensor measurement. A second root mean squared deviation for the error between the index from the model based on the slippery road surface and the index calculated from sensor measurement. Probability density functions are determined in response to the calculated first and second root mean squared deviations. A probability analysis is applied as a function of the probability density functions for identifying the condition of the road surface. The condition of the road surface is identified between a non-slippery road surface and a slippery road surface.

An embodiment contemplates a method of determining a state of a road condition using a linear model-based estimation technique. Two vehicle reference models are defined to represent vehicles operating under non-slippery and slippery road surfaces respectively. An index that reflects the vehicle understeer characteristics is also defined. Based on the reference models and vehicle sensor measurement, three indices are determined from the reference models under a non-slippery road surface and a slippery road surface, and from sensor measurement respectively in response to the vehicle operating characteristics. A first root mean square deviation is calculated between the index of reference model under non-slippery road surface and the index calculated based on sensor measurement. A second root mean square deviation is calculated between the index of reference model under slippery road surface and the index calculated based on sensor measurement. Probability density functions are then determined in response to the calculated first and second root mean squared deviations. A probability analysis is applied as a function of the probability density functions for identifying the condition of the road surface. The condition of the road surface is identified between a non-slippery road surface and a slippery road surface.

An embodiment contemplates a method of determining a state of a road condition using a linear model-based estimation technique. A count is reset to an initial setting. Driver operating input data is obtained. A linear model-generated index is determined for a non-slippery road surface. A linear model-generated index is determined for a slippery road surface. An index is determined as a function of a measured yaw rate. A root mean square deviation of an error is calculated between the non-slippery road surface index and the index determined as a function of the measured yaw rate. A root mean square deviation of an error is calculated between the slippery road surface index and the index determined as a function of the measured yaw rate. A probability density function of the index of the non-slippery road surface is determined. A probability density function of the index of the slippery road surface is determined. Steps (b) through (j) are repeated until the count value equals a predetermined value. An average probability function is calculated for the index of the non-slippery road surface. An average probability function is calculated for the index of the slippery road surface. A probability of the road surface being a non-slippery road surface is determined. A probability of the road surface being a slippery road surface is determined.

### BRIEF DESCRIPTION OF DRAWINGS

FIG. 1 is a system flow diagram of the linear model-based approach for surface condition identification.

FIG. 2 is an example line plot of a probability percentage for a vehicle driving on a non-slippery road surface.

FIG. 3 is an example line plot of a probability percentage for a vehicle driving on a slippery road surface.

FIG. 4 is a flowchart for a method for identifying a road surface condition.

### DETAILED DESCRIPTION

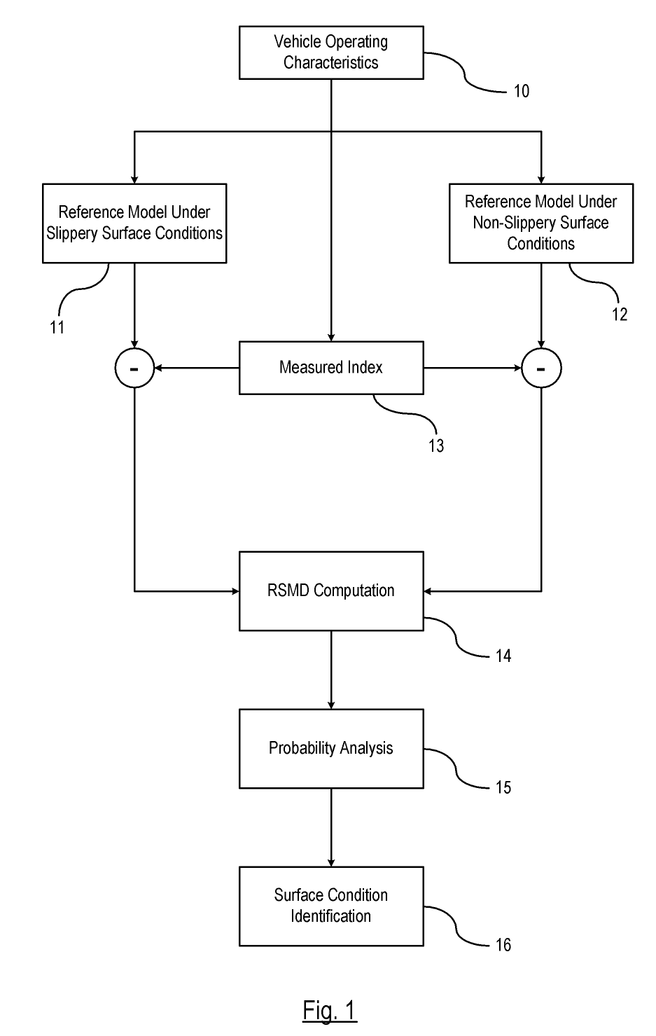

FIG. 1 illustrates a system flow diagram illustrating the road surface identification approach set forth in an embodiment of the invention. The road surface identification approach is conducted under normal driving conditions and provides a binary surface identification output. It is understood that normal driving conditions include a vehicle driven along a road where no evasive maneuvers are required. The road surface identification approach will identify whether the road surface is a non-slippery road surface or a slippery road surface. It should be understood that the binary identification output is only one embodiment of the invention, and that more than two road surface conditions may be identified by this technique.

Models generated for identifying the road surface-based indices as discussed in the embodiments below are linear vehicle models. Under tire non-linear or near-limit operating region, the vehicle dynamics show significant differences between the different road conditions making the identification of the road surface model readily ascertainable. In contrast to tire non-linear or near-limit operating region, the vehicle dynamics show small differences between the different road conditions making the identification of the road surface difficult to ascertain; however, the method in this embodiment requires no evasive maneuvers and no extra sensors or hardware cost as compared to many other approaches. The embodiments that are described herein overcome the difficulties of determining the road surface condition while vehicle driving on a linear tire operating region.

In block 10, vehicle operating characteristics are monitored during the operation of the vehicle. The vehicle operating characteristics that are monitored include the vehicle front wheel steering angle derived by the driver steering input, the vehicle longitudinal velocity, and the vehicle yaw rate. Other vehicle characteristics may include such features as a distance between the front and rear axles of the vehicle. Using a fixed window approach, a counter i is set to 1 with t=0. Vehicle operating characteristics are monitored and recorded at some predetermined time interval.

Blocks 11-13 are calculated indices derived from three variables, specifically, driver steering angle, vehicle longitudinal velocity, and yaw rate. The yaw rates as will be discussed below are calculated based on a model under a respective road surface condition or a sensor based measurement.

In block 11, a model-based index ρ_{g} is computed for a non-slippery road surface condition based on the measured and predetermined vehicle operating characteristics. The equation for determining the index ρ_{g} under a non-slippery road surface condition is as follows:

$${ρ}_{g} = \frac{{δ}_{f} {v}_{x} - {r}_{g} l}{{r}_{g} {v}_{x}^{2}} \qquad ( 1 )$$

where ρ_{g} is the non-slippery road surface index, δ_{f} is a vehicle front wheel steering angle, r_{g} is an estimated vehicle yaw rate based on a model for a given non-slippery road surface, vₓ is a vehicle longitudinal velocity, l is a distance between the front and rear axles of the vehicle.

In block 12, a model-based index ρₛ is computed for a slippery road surface condition. The equation for determining the index ρₛ for a slippery road surface condition is as follows:

$${ρ}_{s} = \frac{{δ}_{f} {v}_{x} - {r}_{s} l}{{r}_{s} {v}_{x}^{2}} \qquad ( 2 )$$

where ρₛ is the slippery road surface index, δ_{f} is a vehicle front wheel steering angle, rₛ is an estimated vehicle yaw rate from a model under slippery road surface, vₓ is a vehicle longitudinal velocity, and l is a distance between the front and rear axles of the vehicle.

The estimated vehicle yaw rates r_{g} and rₛ are determined from two different vehicle models under non-slippery and slippery road surfaces respectively. The road surface influence to vehicle models is characterized by vehicle cornering stiffness which is different for a non-slippery road condition and a slippery road condition. A bicycle mode may be used as vehicle reference model which represents vehicle dynamics very well in a linear region. Cornering stiffness C_{f} and Cᵣ vary under different road surfaces (e.g., non-slippery and slippery), and as result, reflect the influence of road surface to vehicle dynamics. To determine the indices above in equations (1) and (2) for the non-slippery and slippery road surfaces, respectively, respective estimated yaw rates are determined as a function of the cornering stiffness. The vehicle reference model for determining the estimated vehicle yaw rate under each respective road surface condition is represented by the following formula:

$$\begin{matrix}[ \begin{matrix}{\dot{v}}_{y} \\ \dot{r}\end{matrix} ] = [ \begin{matrix}{a}_{11} & {a}_{12} \\ {a}_{21} & {a}_{22}\end{matrix} ] [ \begin{matrix}{v}_{y} \\ r\end{matrix} ] + [ \begin{matrix}{b}_{11} & {b}_{12} \\ {b}_{21} & {b}_{22}\end{matrix} ] [ \begin{matrix}{δ}_{f} \\ {δ}_{r}\end{matrix} ] \\ where , & ( 3 ) \\ {a}_{11} = - \frac{{C}_{f} + {C}_{r}}{{mv}_{x}} , {a}_{12} = - ( \frac{{aC}_{f} - {bC}_{r}}{{mv}_{x}} + {v}_{x} ) \\ {a}_{21} = - \frac{{aC}_{f} - {bC}_{r}}{{I}_{z} {v}_{x}} , {a}_{22} = - \frac{{a}^{2} {C}_{f} + {b}^{2} {C}_{r}}{{I}_{z} {v}_{x}} \\ {b}_{11} = \frac{{C}_{f}}{m} , {b}_{12} = \frac{{C}_{r}}{m} , {b}_{21} = \frac{{aC}_{f}}{{I}_{z}} , {b}_{22} = \frac{{bC}_{r}}{{I}_{z}} & ( 4 )\end{matrix}$$

The equation of the reference model may be rewritten as functions of lateral accelerations and yaw accelerations as follows:

$$\begin{matrix}{A}_{y} = {\dot{v}}_{y} + {rv}_{x} = {a}_{11} {v}_{y} + {a}_{12} r + {b}_{11} {δ}_{f} + {b}_{12} {δ}_{r} + {rv}_{x} = ( - \frac{{v}_{y}}{{mv}_{x}} - \frac{ar}{{mv}_{x}} + \frac{{δ}_{f}}{m} ) {C}_{f} + ( - \frac{{v}_{y}}{{mv}_{x}} - \frac{br}{{mv}_{x}} + \frac{{δ}_{r}}{m} ) {C}_{r} & ( 5 ) \\ \dot{r} = {a}_{21} {v}_{y} + {a}_{22} r + {b}_{21} {δ}_{f} + {b}_{22} {δ}_{r} = ( - \frac{{av}_{y}}{{I}_{z} {v}_{x}} - \frac{{a}^{2} r}{{I}_{z} {v}_{x}} + \frac{a {δ}_{f}}{{I}_{z}} ) {C}_{f} + ( \frac{{bv}_{y}}{{I}_{z} {v}_{x}} - \frac{{b}^{2} r}{{I}_{z} {v}_{x}} - \frac{b {δ}_{r}}{{I}_{z}} ) {C}_{r} & ( 6 )\end{matrix}$$

The above equations are then re-organized into a standard form for recursive least square (RLS) algorithm:

$$Y = {φ}^{T} θ , \text{where} \\ Y = [ \begin{matrix}{A}_{y} \\ \dot{r}\end{matrix} ] , \\ {φ}^{T} = [ \begin{matrix}- \frac{{v}_{y}}{{mv}_{x}} - \frac{ar}{{mv}_{x}} + \frac{{δ}_{f}}{m} & - \frac{{v}_{y}}{{mv}_{x}} + \frac{br}{{mv}_{x}} + \frac{{δ}_{r}}{m} - \\ \frac{{av}_{y}}{{I}_{z} {v}_{x}} - \frac{{a}^{2} r}{{I}_{z} {v}_{x}} + \frac{a {δ}_{f}}{{I}_{z}} & \frac{{bv}_{y}}{{I}_{z} {v}_{x}} - \frac{{b}^{2} r}{{I}_{z} {v}_{x}} - \frac{b {δ}_{r}}{{I}_{z}}\end{matrix} ] , θ = [ \frac{{C}_{f}}{{C}_{r}} ] \qquad ( 7 )$$

Based on the above RLS algorithm, C_{f} and Cᵣ may be estimated for both a non-slippery road surface and a slippery road surface. Respective values for C_{f} and Cᵣ are used to determine the estimate yaw rate for the non-slippery road condition r_{g} and slippery road condition rₛ. The respective yaw rates are inserted into Eq. 1 and 2 for determining the non-slippery road condition index ρ_{g} and the slippery road condition index ρₛ.
In block 13, an index ρₘ is computed based on a yaw rate sensor measurement. The equation for determining the index ρₘ for the current road condition based on the yaw rate is as follows:

$${ρ}_{m} = \frac{{δ}_{f} {v}_{x} - rl}{{rv}_{x}^{2}} \qquad ( 8 )$$

where ρₘ is the current road index as a function of the yaw rate sensor measurement, δ_{f} is a vehicle front wheel steering angle, r is a vehicle yaw rate for the currently driven road surface based on a sensor measurement, vₓ is a vehicle longitudinal velocity, and l is a distance between the front and rear axles of the vehicle.

In block 14, respective root mean square deviations (RMSD) are determined as a function of the indices. The two RMSD of index differences are calculated between measured index ρₘ and index calculated under a non-slippery road surface ρ_{g} and an index under a slippery road surface ρₛ. The respective RMSD values represent the errors between the reference model-generated indices (ρ_{g}, ρₛ) and the index ρₘ. That is, the RMSD is a measure of the difference between the values determined by the model and those values based on the yaw rate sensor measurement.

The following embodiment utilizes a fixed window approach. Equation (4) computes an index error between the non-slippery road surface model and the measured road surface condition. The equation used to calculate the RMSD for the non-slippery road surface indices for the fixed window approach is as follows:

$${γ}_{1} = R M S D ( {ρ}_{g} , {ρ}_{m} ) = \sqrt{M S E ( {ρ}_{g} , {ρ}_{m}} = \sqrt{E ( {( {ρ}_{g} - {ρ}_{m} )}^{2} )} \\ {γ}_{1} = \sqrt{\frac{{\sum }_{k = 1}^{i} {( {ρ}_{gk} - {ρ}_{mk} )}^{2}}{i}} ( i = 1 , … M ) \qquad ( 9 )$$

The following equation is used to calculate the RMSD for the slippery road surface indices:

$${γ}_{2} = R M S D ( {ρ}_{s} , {ρ}_{m} ) = \sqrt{M S E ( {ρ}_{s} , {ρ}_{m}} = \sqrt{E ( {( {ρ}_{s} - {ρ}_{m} )}^{2} )} \\ {γ}_{2} = \sqrt{\frac{{\sum }_{k = 1}^{i} {( {ρ}_{sk} - {ρ}_{mk} )}^{2}}{i}} ( i = 1 , … M ) \qquad ( 10 )$$

Equation (10) computes an index error between the non-slippery road surface model and the measured road surface condition. In equations (9) and (10), i is a count value at which respective vehicle operating characteristics are measured for calculating the indices and RMSD error values. The indices and RMSD are calculated up to a predetermined number of count values (M).

In block 15, a probability analysis is performed based on the determined indices for identifying the road surface condition. Once a sufficient number of samples have been computed, then an average probability density function is determined for a non-slippery road surface condition and a slippery road surface condition. The probability density function for data obtained at a respective count value for a non-slippery road surface condition is determined by the following equation:

$${ρ}_{i} ( ρ \vert {s}_{g} ) = \frac{{γ}_{2}}{{γ}_{1} + {γ}_{2}} \qquad ( 11 )$$

The average probability density function for the non-slippery road surface condition is determined by the following equation:

$${ρ}_{avg} ( ρ \vert {s}_{g} ) = \frac{{\sum }_{i = 1}^{M} {ρ}_{i} ( ρ \vert {s}_{g} )}{M} \qquad ( 12 )$$

The probability density function for a respective count value for a slippery road surface condition is determined by the following equation:

$${ρ}_{i} ( ρ \vert {s}_{s} ) = \frac{{γ}_{1}}{{γ}_{1} + {γ}_{2}} \qquad ( 13 )$$

The average probability density function for the slippery road surface condition is determined as follows:

$${ρ}_{avg} ( ρ \vert {s}_{s} ) = \frac{{\sum }_{i = 1}^{M} {ρ}_{i} ( ρ \vert {s}_{s} )}{M} \qquad ( 14 )$$

In block 16, the condition of the road surface is identified. After determining an index derived as a function of the average probability function of the non-slippery road surface condition, Bayes' Rule is used to determine the final likelihood of whether the vehicle is traveling on a non-slippery road surface. The equation for determining the likelihood that the vehicle is traveling on a non-slippery road surface is determined is as follows:

$$P ( {s}_{g} \vert {ρ}_{m} ) = \frac{P ( {ρ}_{m} \vert {s}_{g} ) \cdot P ( {s}_{g} )}{P ( {ρ}_{m} )} \approx \frac{p ( {ρ}_{m} \vert {s}_{g} ) \cdot P ( {s}_{g} )}{p ( {ρ}_{m} \vert {s}_{g} ) \cdot P ( {s}_{g} ) + p ( {ρ}_{m} \vert {s}_{s} ) \cdot P ( {s}_{s} )} \qquad ( 15 )$$

Similarly, the final likelihood that the vehicle is traveling on the slippery road surface using Bayes' Rule is determined by the following equation:

$$P ( {s}_{s} \vert {ρ}_{m} ) = \frac{P ( {ρ}_{m} \vert {s}_{s} ) \cdot P ( {s}_{s} )}{P ( {ρ}_{m} )} \approx \frac{p ( {ρ}_{m} \vert {s}_{s} ) \cdot P ( {s}_{s} )}{p ( {ρ}_{m} \vert {s}_{g} ) \cdot P ( {s}_{g} ) + p ( {ρ}_{m} \vert {s}_{s} ) \cdot P ( {s}_{s} )} \qquad ( 16 )$$

The results of equations (15) and (16) are the final likelihood in percentage of a road surface being on a non-slippery or a slippery condition. The results of Eq. (15) represent the probability the vehicle is traveling on the non-slippery road surface. The result of Eq. (16) determines the likelihood in percentage that the vehicle is traveling on a slippery road surface.

A return is made to step 10 to update the probability percentage (i.e., likelihood of the road surface being a non-slippery road surface or a slippery road surface). If a fixed window approach is used, the count value and time value is reset to their initial values (i.e., i=1, t=0). Steps 10-16 are repeated. Alternatively, moving window approach (e.g., recursive approach) may be used. In block 14, a recursive approach may be used to determine the RMSD between the indices for updating the probability (final likelihood) for being on a non-slippery surface or a slippery surface. In this embodiment, the data obtained from a previous recordation of i=1 to M is buffered and maintained. The average is updated with newly added data i=M+1 as opposed to the fixed window approach where the buffer is cleared and entirely new values for i=1 to M are obtained. The moving window approach for determining the RMSD is shown by the following formulas:

$$\begin{matrix}{γ}_{1} = R M S D ( {ρ}_{g} , {ρ}_{m} ) = \sqrt{\frac{{\sum }_{i = 1}^{M} {( {ρ}_{g} [ i ] - {ρ}_{m} [ i ] )}^{2}}{M}} , \\ and & ( 17 ) \\ {γ}_{2} = R M S D ( {ρ}_{s} , {ρ}_{m} ) = \sqrt{\frac{{\sum }_{i = 1}^{M} {( {ρ}_{s} [ i ] - {ρ}_{m} [ i ] )}^{2}}{M}} & ( 18 )\end{matrix}$$

The probability density functions would then be computed for both indices using the values for the RMSD obtained in Eq. (15) and (16). To determine the average probability function, i is not reset to 1; rather the stored data within the buffer is updated with new data. Under this approach, the RSMD values for i=2 to M+1 is used to update the average probability function. The next value determined for the average probability function will utilized the values i=3 to M+2. This approach will continue using a recursive method by utilizing previous RSMD values stored in the buffer with the newly added data.

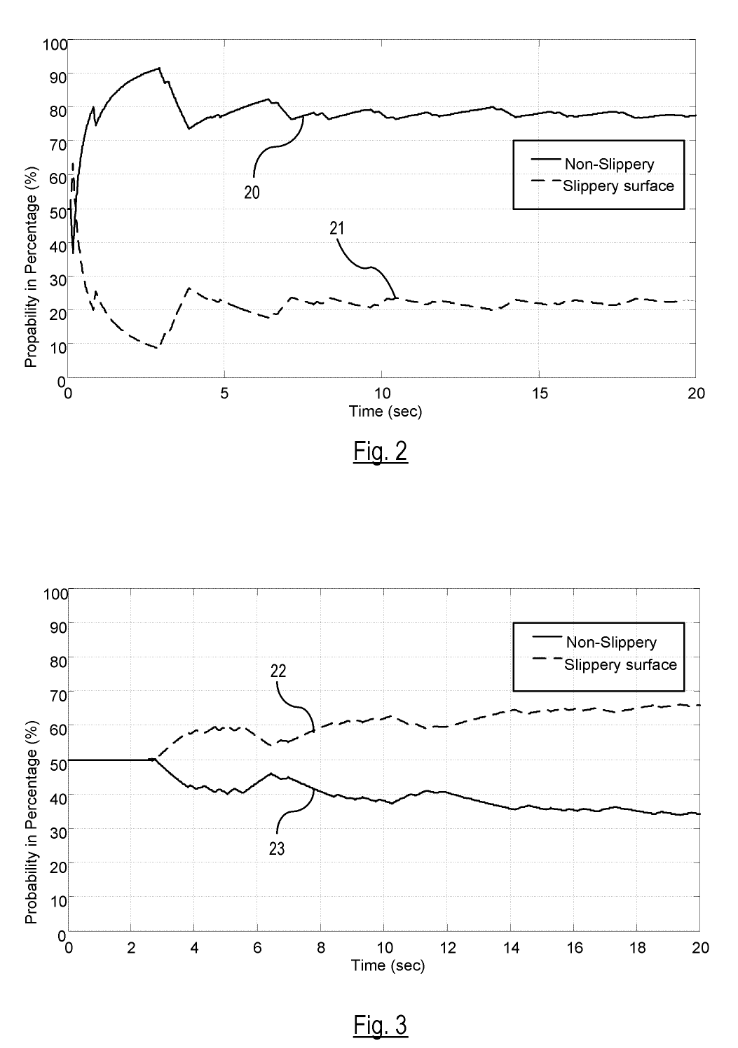

FIG. 2 illustrates an example plot of the probability percentages derived at the various instances of time for a vehicle traveling on a respective non-slippery surface. In FIG. 6, a line plot 20 is representative of the probability percentage for a non-slippery surface derived at each time interval. Also shown in the FIG. 6 is a plot line 21 illustrating the probability percentage of the road surface being a slippery surface. If the condition identification of the road surface binary (i.e., non-slippery or slippery), then the probability percentages of the two conditions must equal 100 percent. Therefore, the plotted lines of the probability percentage of the non-slippery surface and the probability percentage of the slippery surface are mirror images of one another. That is, since there are only two possible conditions that can exist for a binary result, the two probability percentages must add up to 100 percent and any respective time interval. Therefore, both plotted lines 20 and 21 mirror image one another at the 50 probability percentage line. The plot having the highest probability percentage of the two is selected as the likelihood of the road surface that the vehicle is traveling on.

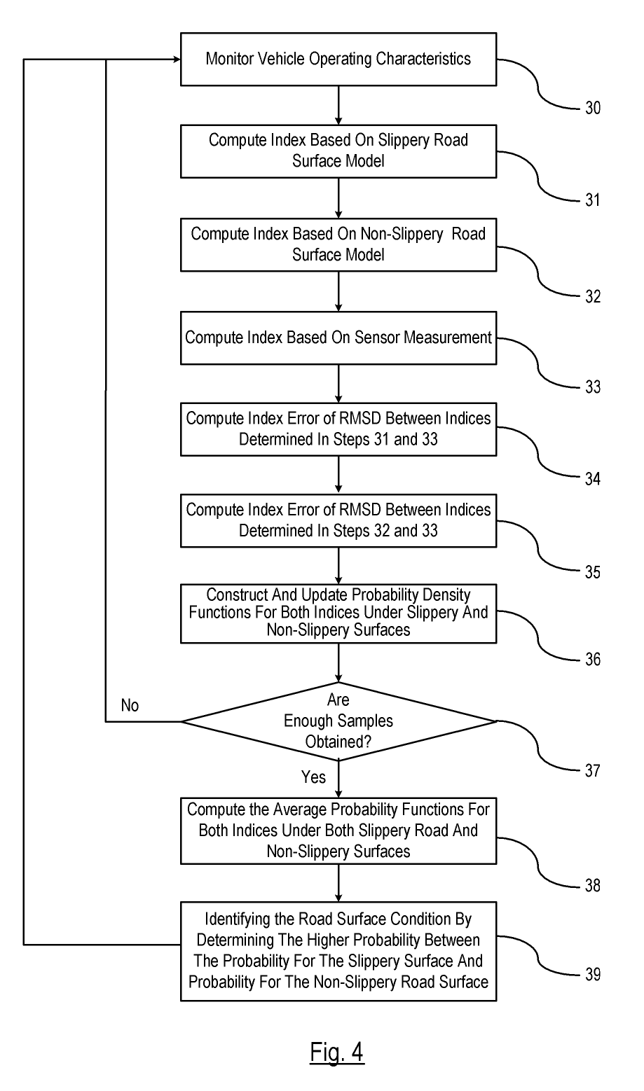

FIG. 3 is an example line plot of a probability percentage for surface condition identification for a vehicle traveling on a slippery road surface. A slippery road surface is identified at plot 22 and the non-slippery road surface is identified at plot line 23. It is noted that the plot 22 and plot 23 are mirror images of one another above and below the 50 percent mark.

FIG. 4 is a flowchart for a method for identifying the surface condition of a vehicle road for which a vehicle is traveling.

In step 30, the vehicle operating characteristics are monitored, specifically, the front wheel steering angle, vehicle yaw rate, and the vehicle longitudinal velocity.

In step 31, respective vehicle operating characteristics are used to determine indices of the slippery road surface model that include driver steering angle, vehicle longitudinal velocity, and an estimated vehicle yaw rate based on a model for a slippery road surface.

In step 32, respective vehicle operating characteristics are used to determine indices of the non-slippery road surface model that include driver steering angle, vehicle longitudinal velocity, and an estimated vehicle yaw rate based on a model for a non-slippery road surface.

In step 33, indices are determined for the current road surface traveled using respective vehicle operating characteristics that include driver steering angle, vehicle longitudinal velocity, and an estimated vehicle yaw rate based on sensor measurement. Current road surface indices are calculated for comparison with the respective model-based indices.

In step 34, the RMSD is determined for the index error between the values determined by the non-slippery road surface model and the measured road condition.

In step 35, the RMSD is determined for the index error between the values determined by the slippery road surface model and the measured road condition.

In step 36, a probability density function is determined and updated for the non-slippery and slippery road surface conditions, respectively.

In step 37, a determination is made of whether enough samples have been obtained to construct the probability density function for both the non-slippery road surface condition and the slippery road surface condition. If the determination is made in step 37 that the more samples are required, then a return is made to step 30 to obtain the samples. If the determination is made that enough samples have been obtained, then the routine proceeds to step 38 where an average probability density function is determined for both the non-slippery road surface condition and the slippery road surface condition.

In step 38, Bayes' rule is used to obtain respective probability percentages for the vehicle being a non-slippery road surface and a slippery road surface. The probability percentages for the vehicle being a non-slippery road surface are plotted on a graph versus time. In addition, the probability percentages for the vehicle being a slippery road surface are plotted on a graph versus time.

In step 39, the higher probability percentage associated with either the non-slippery road surface or the slippery road surface is selected as that respective road surface that the vehicle is traveling on.

While certain embodiments of the present invention have been described in detail, those familiar with the art to which this invention relates will recognize various alternative designs and embodiments for practicing the invention as defined by the following claims.

What is claimed is:

1. A method of determining a state of a road condition using a linear model-based estimation technique, the method comprising the steps of:
determining an index which represents a vehicle understeer characteristic for a vehicle model based on a non-slippery road surface;
determining an index which represents a vehicle understeer characteristic for a vehicle model based on a slippery road surface;
determining an index which represents a vehicle understeer characteristic for a vehicle on current traveled road based on sensor measured vehicle operating characteristics that include a measured yaw rate;
calculating a first root mean squared deviation for an error between the index from a model based on the non-slippery road surface and the index calculated from sensor measurement, and a second root mean squared deviation for the error between the index from a model based on the slippery road surface and the index calculated from sensor measurement;
determining probability density functions in response to the calculated first and second root mean squared deviations;
applying a probability analysis as a function of the probability density functions for identifying the condition of the road surface; and
identifying the condition of the road surface between a non-slippery road surface and a slippery road surface.

2. The method recited in claim 1 wherein identifying the condition of the road surface is selected from one of binary road surface conditions.

3. The method recited in claim 1 wherein a vehicle front wheel steering angle is a vehicle operating characteristic used to determine each of the indices, the front wheel steering angle being derived by the driver's steering input.

4. The method of claim 1 wherein a plurality of probability density function values is determined based on the non-slippery road model surface indices, and wherein an average value is determined based on the plurality of probability density function values.

5. The method of claim 4 wherein the probability analysis comprises determining an average probability density function value for the non-slippery road model surface indices.

6. The method of claim 5 wherein the probability analysis is based on Bayes' rule.

7. The method of claim 6 wherein the probability analysis is based on recursive probability analysis for determining a probability percentage of the road surface being a non-slippery road surface.

8. The method of claim 7 wherein a plurality of probability density function values is determined based on the slippery road model surface indices, and wherein an average value is determined for the plurality of probability density function values.

9. The method of claim 8 wherein the average value of the probability density function values for the slippery road model surface indices are applied to the probability analysis.

10. The method of claim 9 wherein the probability analysis is based on Bayes' rule.

11. The method of claim 10 wherein the probability analysis is based on recursive probability analysis for determining a probability percentage of the road surface being a slippery road surface.

12. The method of claim 11 wherein the identification of the condition of the road surface includes determining the higher probability percentage between the probability percentage of the slippery road surface and the probability percentage of the non-slippery road surface.

13. The method of claim 1 wherein the non-slippery road surface index comprises determining an estimated yaw rate for a non-slippery road surface, the estimated yaw rate derived as a function of a front and rear axle cornering stiffness.

14. The method of claim 13 wherein the front and rear axle cornering stiffness for the slippery road surface is estimated using a recursive least square technique.

15. The method of claim 1 wherein the slippery road surface index is determined as a function of an estimated yaw rate for a slippery road surface, the estimated yaw rate derived as a function of a front and rear axle cornering stiffness.

16. The method of claim 15 wherein the front and rear axle cornering stiffness for the slippery road surface is estimated using a recursive least square technique.

17. A method of determining a state of a road condition using a linear model-based estimation technique, the method comprising the steps of:
(a) resetting a count to an initial setting;
(b) obtaining vehicle operating characteristic data;
(c) determining a model generated index for a non-slippery road surface;
(d) determining a model generated index for a slippery road surface;
(e) determining an index as a function of a measured yaw rate;
(f) calculating a root mean square deviation of an error between the non-slippery road surface index and the index determined as a function of the measured yaw rate;
(g) calculating a root mean square deviation of an error between the slippery road surface index and the index determined as a function of the measured yaw rate;
(h) determining a probability density function of the index of the non-slippery road surface;
(i) determining a probability density function of the index of the slippery road surface;
(j) repeating steps (b) through (j) until the count value equals a predetermined value;
(k) calculating an average probability function for the index of the non-slippery road surface;
(l) calculating an average probability function for the index of the slippery road surface;
(m) determining a probability of the road surface being a non-slippery road surface;
(n) determining a probability of the road surface being a slippery road surface; and
(o) identifying the condition of the road surface in response to determining the higher probability between step (m) and step (n).

18. The method of claim 17 wherein updating the probabilities of the non-slippery road surface and the slippery road surface is performed by repeating steps (a)-(o).

19. The method of claim 17 wherein updating the probabilities of the non-slippery road surface and the slippery road surface further comprises the steps of:
(p) buffering the data obtained in steps (a)-(n);
(q) eliminating a first count value in the buffer;
(r) incrementing the predetermined count value;
(s) obtaining vehicle characteristic data for the incremented count value;
(t) performing steps (c)-(i);
(u) adding the resulting probability density functions to the buffer; and
(v) performing steps (k)-(o) using the buffered data.

20. The method of claim 19 wherein the non-slippery and slippery road surface indices are each determined as a function of an estimated yaw rate for a non-slippery road surface and slippery road surface, respectively, the estimated yaw rates being derived as a function of a front and rear axle cornering stiffness for a non-slippery road surface and slippery road surface, respectively.
